(19) United States
(12) Patent Application Publication
(10) Pub. No.: US 2025/0243690 A1
(43) Pub. Date: Jul. 31, 2025

(54) CABLE SEAL LOCK WITH RFID & BLE

(71) Applicant: E.J. Brooks Company d.b.a. TydenBrooks, Atlanta, GA (US)

(72) Inventors: Vincent L. Smith, Edgefield, SC (US); Kelvin A. Cannady, Atlanta, GA (US); Benjamin T. Rogers, New York, NY (US)

(21) Appl. No.: 19/038,083

(22) Filed: Jan. 27, 2025

Related U.S. Application Data
(60) Provisional application No. 63/626,006, filed on Jan. 28, 2024.

(51) Int. Cl. E05B 45/00

(52) U.S. Cl. CPC E05B 45/005

(57) ABSTRACT

A lock structure includes an interior body having first and second openings and a cable wire. The interior body is configured to retain first and second ends of the cable wire when in a locked state. The lock structure further includes an electrical sensing device disposed within the cable wire, the electrical sensing device including a first end and a second end, and a signal sensing module electrically coupled to the electrical sensing device only at the first end of the electrical sensing device. The signal sensing module is configured to monitor, via the first end of the electrical sensing device, at least one of electrical and temperature characteristics of the electrical sensing device and selectively generate a notification indicating whether the cable wire is in a tampered-with state or untampered-with state based on the at least one of the electrical and temperature characteristics.

### CROSS-REFERENCE TO RELATED APPLICATIONS

This application claims the benefit of U.S. Provisional Application No. 63/626,006, filed on Jan. 28, 2024. The entire disclosure of the application referenced above is incorporated herein by reference.

### FIELD

The present disclosure generally relates to a disposable cable seal lock operatively connected to an electrical sensing device to monitor tampering.

### BACKGROUND

A cable lock unit may be used to lock large doors with two spaced apart pieces to be locked together (such as the doors of a shipping container). In such instances, the cable seal lock may lock the doors together by feeding the cable through the openings in the spaced apart pieces and then passing the cable back into the cable lock opening. Typically, a cable seal lock has a lock state or locked condition in which the cable is inserted into the body of the cable seal lock, and an unlocked state in which the cable is not inserted into the body of the cable seal lock.

### SUMMARY

A lock structure includes an interior body having first and second openings and a cable wire. The interior body is configured to retain first and second ends of the cable wire when in a locked state. The lock structure further includes an electrical sensing device disposed within the cable wire, the electrical sensing device including a first end and a second end, and a signal sensing module electrically coupled to the electrical sensing device only at the first end of the electrical sensing device. The signal sensing module is configured to monitor, via the first end of the electrical sensing device, at least one of electrical and temperature characteristics of the electrical sensing device and selectively generate a notification indicating whether the cable wire is in a tampered-with state or untampered-with state based on the at least one of the electrical and temperature characteristics.

In other features, the electrical sensing device includes a flexible printed circuit coupled to the signal sensing module. The flexible printed circuit is disposed between the cable wire and an outer layer enclosing the cable wire. The electrical sensing device extends from the signal sensing module substantially along a length of the cable wire and terminates at a portion of the cable wire that is enclosed within the lock structure when in the locked state.

In other features, the electrical sensing device includes a sensing wire embedded within the cable wire. The cable wire includes a plurality of wires and the sensing wire is embedded within the plurality of wires. The sensing wire is enclosed within an insulation layer that electrically insulates the sensing wire from the plurality of wires. The insulation layer extends from a first end of the sensing wire and terminates prior to a second end of the sensing wire within the cable wire such that the second end of the sensing wire is in electrical contact with the cable wire. The insulation layer terminates at a portion of the cable wire that is enclosed within the lock structure when in the locked state. The insulation layer is transparent. The sensing wire has a substantially same diameter as individual wires of the plurality of wires.

In other features, the signal sensing module includes radio frequency identification (RFID) circuitry configured to generate and transmit the notification. The signal sensing module includes Bluetooth circuitry configured to generate and transmit the notification. The Bluetooth circuitry include Bluetooth low energy (BLE) circuitry.

In other features, the electrical sensing device includes a flexible printed circuit coupled to the signal sensing module. The electrical sensing device extends from the signal sensing module substantially along a length of the cable wire and terminates at a portion of the cable wire that is enclosed within the lock structure when the lock structure is in a locked state. The electrical sensing device includes a sensing wire embedded within the cable wire.

In other features, the cable wire includes a plurality of wires and the sensing wire is embedded within the plurality of wires. The sensing wire is enclosed within an insulation layer that electrically insulates the sensing wire from the plurality of wires. The insulation layer extends from a first end of the sensing wire and terminates prior to a second end of the sensing wire within the cable wire such that the second end of the sensing wire is in electrical contact with the cable wire. The insulation layer terminates at a portion of the cable wire that is enclosed within the lock structure when in the lock structure is in a locked state. The insulation layer is transparent.

In other features, the signal sensing module includes at least one of radio frequency identification (RFID) circuitry configured to generate and transmit the notification and Bluetooth circuitry configured to generate and transmit the notification.

These and other embodiments are disclosed or are obvious from and encompassed by the following Brief Description of the Drawings and Detailed Description.

### BRIEF DESCRIPTION OF THE DRAWINGS

The present disclosure will become more fully understood from the detailed description and the accompanying drawings, wherein:

FIG. 1 is a perspective view of disposable cable seal lock in accordance with the present disclosure.

FIG. 2 is a perspective view of the housing of the cable seal lock of FIG. 1.

FIG. 3 is an exploded view of the cable seal lock of FIG. 1.

FIGS. 4A and 4B show partially broken away views of internal components within the housing of the cable seal lock of FIGS. 1-3.

FIG. 5 is a partial exploded view of the cable seal lock of FIG. 1.

FIG. 6 depicts an exploded view of the cable seal lock of FIG. 1.

FIG. 7 is a view of various embodiments of a cable seal lock in accordance with the present disclosure.

FIG. 8 is a perspective view of a second embodiment of a disposable cable seal lock in accordance with the present disclosure.

FIG. 9 is an exploded view of the cable seal lock of FIG. 8.

FIG. 10 is a focused view of the inlay, cable, and spring assembly of the cable seal lock of FIG. 8.

FIG. 11 is a perspective view of a third embodiment of a disposable cable seal lock in accordance with the present disclosure.

FIG. 12 is an exploded view of the cable seal lock of FIG. 11.

FIG. 13 is a second exploded view of the cable seal lock of FIG. 11.

FIG. 14 is a view of the internal components within the housing of the cable seal lock of FIG. 11.

FIG. 15 is a view of the insert assembly of the cable seal lock of FIG. 11.

FIG. 16 is a side view of the interior body of the insert assembly separated from the base housing of the insert assembly of the cable seal lock of FIG. 11.

FIG. 17 depicts a standard BLE chipset for use in connection with a cable seal lock of the present disclosure.

FIG. 18 depicts a flow diagram of the functionality of the BLE chipset when used in connection with a cable seal lock of the present disclosure.

FIG. 19 depicts an inlay for use in connection with an RFID chip and cable seal lock of the present disclosure.

FIG. 20 depicts a schematic of a standard RFID system.

FIG. 21 a flow diagram of a standard RFID system when used in connection with a cable seal lock of the present disclosure.

FIG. 22 shows a functional block diagram of an example cable seal lock according to the present disclosure.

FIGS. 23 and 24 show an example of the locking mechanism implemented as a wire rope or cable wire according to the present disclosure.

FIG. 25 shows a block diagram of an example computing device configured to implement functions of the systems and methods of the present disclosure.

### DETAILED DESCRIPTION

The following detailed description, given by way of example, but not intended to limit the principles of the present disclosure solely to the specific embodiments described, may best be understood in conjunction with the accompanying drawings.

Lock structures may use various types of locking mechanisms or shackles, including, but not limited to rigid shackles (referred to herein as “shackles”) and cable shackles (referred to herein as “cables” or “cable shackles”). For example, the lock structure may include openings configured to receive, retain, and/or selectively release ends of the locking mechanisms. One example lock structure (e.g., a cable seal lock) is described in U.S. Provisional Patent Application No. 63/626,006, filed on Jan. 28, 2024, the entire contents of which are incorporated herein by reference.

While some cable seal locks provide some limited measures to prevent tampering of the cable seal lock, there is a long-felt unmet need to wirelessly transmit a notification, message, or alarm to a user to alert the user that the cable seal lock has been tampered with. By incorporating radio frequency identification (RFID) and Bluetooth low energy (BLE) technologies into the cable seal lock, users may be wirelessly alerted to damage to or tampering with the seal.

The present disclosure relates a disposable cable seal lock that may include a body or housing, a signal sensing unit, an electrical sensing device and a cable. The signal sensing unit may include a printed circuit board and/or substrate and a conductive device. The substrate (such as an inlay) may be comprised of a polyester film (such as Biaxially-oriented polyethylene terephthalate, which may be referred to BoPET or Mylar®) or similar material. The conductive device may be any metallic material capable of electrical conduction for the electrical sensing device. The electrical sensing device may include a printed wire that is disposed with the steel cable. One end of the electrical sensing device is electrically connected to the substrate to form a path. Therefore, when the cable is cut, the electrical sensing device is also cut, resulting in an abnormal circuit detection. Cable temperature is monitored to know whether any heat is being applied in attempt to tamper. Knowing this information, the user can ascertain that the container cargo may have been stolen or tampered with and such information may be readily communicated by RFID (upon scanning) or Bluetooth via a hub disposed on the container to which the cable seal lock is connected. Alternatively, such information may be readily communicated by RFID (upon scanning) or alternatively Bluetooth directly to a smartphone or other wireless device.

The present disclosure provides several advantages. Specifically, by use of RFID, seal status can be quickly and accurately detected by simply scanning the cable seal lock. Further, there is no need to have personnel (such as on a tanker or vessel), scale significant heights to manually inspect seals installed on various doors of shipping containers. In addition, when the present disclosure is deployed with a cellularly connected (or other long-range wireless- or satellite communication-enabled) “hub” device, the cable seal lock which incorporates BLE will be able to update the status of cable seal lock in real time to alert a user when a seal is breached. Finally, the 3-state RFID cable seal lock, when scanned, will accurately show the seal in one of the following states: (1) open, (2) closed, or (3) tampered with.

### First Embodiment of Cable Seal Lock

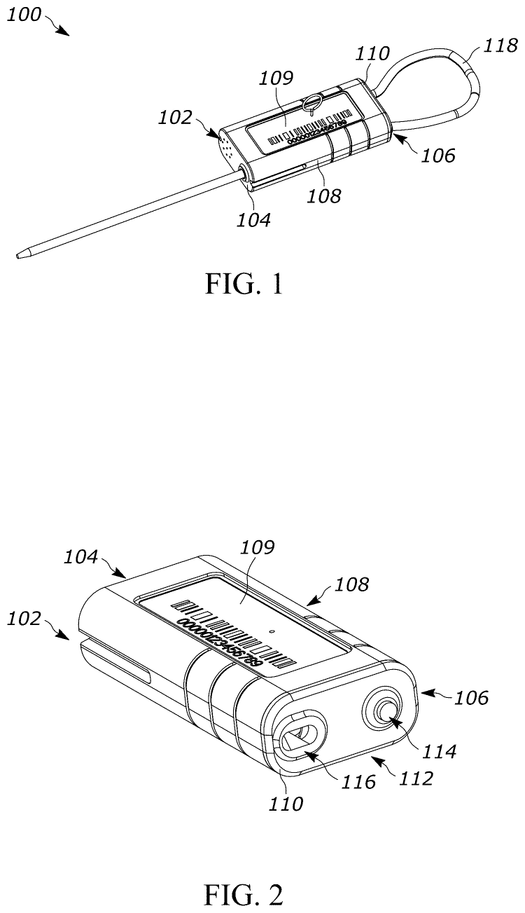

FIGS. 1-6 depict an example embodiment of a lock structure, such as a cable seal lock 100 (which may be disposable), according to the present disclosure. The cable seal lock 100 may include a housing 102, a cable wire (or wire cable) 118, an electrical sensing device 122, and a signal sensing unit 134. Each of these components is described further in the paragraphs below.

### Housing

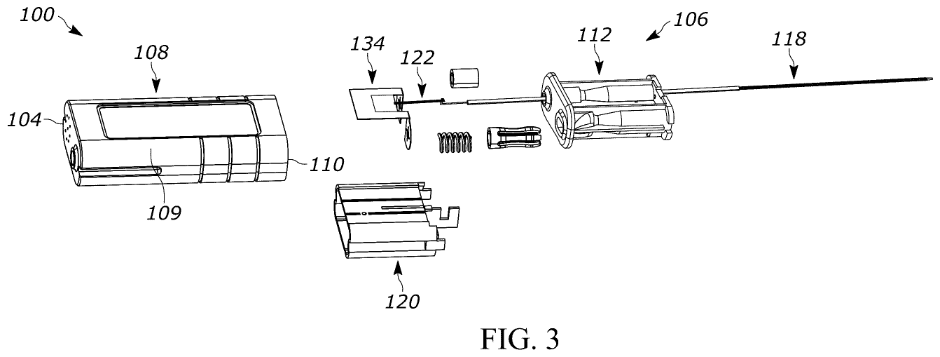

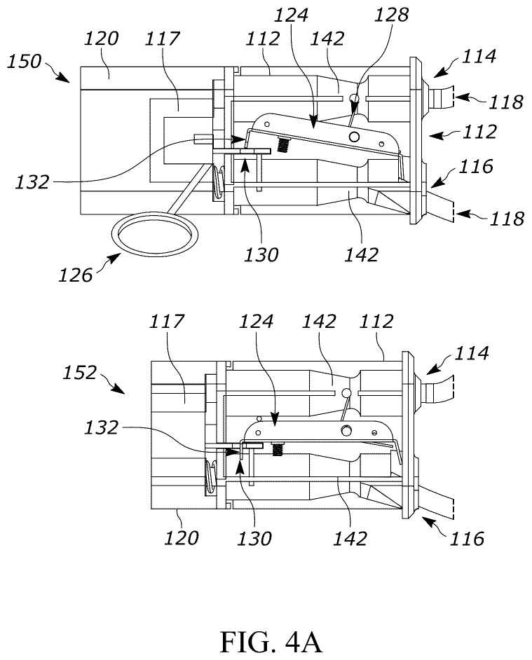

FIG. 2 depicts an embodiment of the housing 102 of the cable seal lock 100, which may include a bottom end 104 and side walls or sidewalls 108 that cooperatively define a sleeve 109 having an open or top end 110 and an insert assembly 106. FIG. 3 shows an exploded view of the cable seal lock 100.

The insert assembly 106 may include an interior body 112 and a base housing 120 that are snap-fit together and disposed within the sleeve 109. An inner end of the interior body 112 is contiguous with an outer end of the base housing 120 and the inner end of the base housing 120 is disposed adjacent the first end 104. An outer end of the interior body 112 may extend from the sleeve 109 to close the open end 110 of the sleeve 109 when connected to the housing 102.

The interior body 112 may include a first opening 114 and a second opening 116 which are each formed in the outer end of the interior body 112 and extend through the interior body 112 to define a passageway. The base housing 120 likewise includes a pair of passageways that are aligned with the first and second openings 114, 116.

In an example embodiment, the first opening 114 and second opening 116 extend straight through the interior body 112 and base housing 120. In another embodiment, the second opening 116 may include a lead-in ramp proximate the top end of the housing 102 including a wall of the lead-in ramp having approximately a 45 degree angle so that the opening 116 has a generally oval configuration. The lead-in ramp facilitates insertion of the cable 118 and disposition of the cable 118 to enable functionality of the cable seal lock 100.

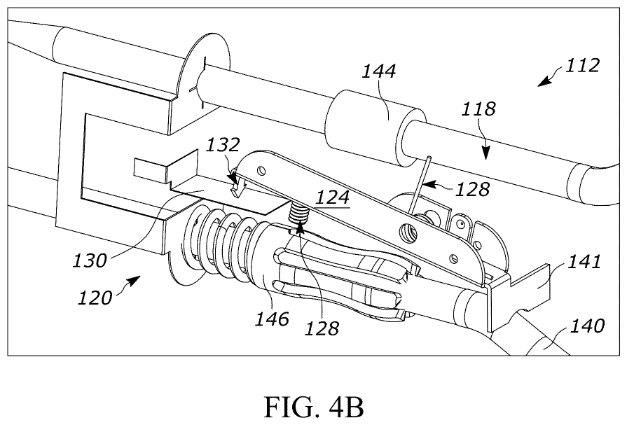

FIGS. 4A and 4B depict internal components of the cable seal lock 100 disposed along the interior body 112. As shown, the internal components comprise a lever 124, a pin 126, a tamper detector 130, and a tamper pin 132. FIG. 4B depicts a view of internal components of the cable seal lock 100 showing the interior body 112 and the base housing 120 in more detail. The base housing 120 comprises first and second openings 117 configured to align with the openings 114, 116 of the interior body 112. In an embodiment, the base housing 120 is disposed flush with the interior body 112 such that the openings 117 of the base housing 120 and the openings 114, 116 of the interior body 112 are aligned.

As shown in FIG. 4A, a cable wire 118 is disposed within housing 102. In an embodiment, a first end of the cable wire 118 is secured within a first opening of the base housing 120. The wire 118 extends through the first opening 114 of the interior body 112. An operator manipulates the wire 118 to form a U-shape which redirects the wire 118 back into the second opening 116 of the interior body 112, through the second opening of the base housing 120, and out the bottom end 104 of the housing 102.

In an embodiment, respective passageways of the first opening 114 and the second opening 116 of the interior body 112 comprise catches 142 and a portion of the wire 118 proximate the passageway of the first opening 114 is securely fastened to a plug 144. In the event that the wire 118 becomes detached from the base housing 120, engagement of the catch 142 and the plug 144 will prevent the wire 118 from being removed from the cable seal lock 100 via the first opening 114. Specifically, the plug 144 will be unable to pass through the catch 142 within the interior body 112.

In an embodiment, the passageway of the second opening 116 of the interior body 112 may similarly comprise the catch 142 and the portion of the wire 118 proximate the passageway of the second opening 116 is securely fastened to a second plug 146. The catch 142 and second plug 146 will prevent the wire 118 from being removed from the cable seal lock 100 via the second opening 116. Specifically, the second plug 146 will be unable to pass through the catch 142 within the interior body 112.

As shown in FIG. 4A, the cable seal lock 100 may comprise a first, untampered-with position (as shown at 150) as well as a second, tampered-with position (as shown at 152). In the untampered-with position, the wire 118 within the cable seal lock 100 forms a U-like shape between the first opening 114 and second opening 116 (external to the housing, as shown by the wire 118 in FIGS. 1, 5, and 6). If the cable wire 118 is cut in half, the cable wire 118 will enter the tampered-with position, wherein each half of the wire 118 within the cable seal lock 100 runs straight through the first opening 114 and second opening 116 respectively.

Due to the tensile strength of the wire 118 itself, tampering with the wire 118 (by cutting the wire 118 along the U-like shape) will result in the wire 118 changing from the untampered-with position into the tampered-with position.

As shown in FIGS. 4A and 4B, when the cable seal lock 100 is in the untampered-with position, such as shown in detail in FIG. 4B, the lever 124 is oriented at an angle such the tamper pin 132 disposed at one end of the lever 124 is spaced apart from the tamper detector 130. On the other side of the lever 124, opposite the tamper pin 132 and proximate a lead in ramp 140 is a wedge 141 (e.g., a wedge or tab extending approximately perpendicularly from the lever 124 toward the wire 118). The wedge 141 extends from the lever 124 and abuts the portion of the cable wire 118 disposed within the lead in ramp 140. The lever 124 is oriented by the position of springs 128 within the interior body 112. These springs 128 contact the wire 118 and apply a force to the lever 124 to maintain the position of the lever 124 such that the tamper pin 132 remains spaced apart from the tamper detector 130.

When the cable seal lock 100 is in the untampered-with position, the wire 118 disposed within the lead in ramp 140 of the second opening 116 is at an angle (preferably 45 degrees) from the top end 106 of the housing 102. In this orientation the wire 118 does not engage the springs 128.

Once the wire 118 is tampered with, the cable seal lock 100 and the wire 118 enter into the tampered-with position. In the tampered-with position, the wire 118 is disposed within the lead in ramp 140 of the second opening 116 at a 90 degree angle from the top end 106 of the housing 102. In this orientation, the wire 118 engages the wedge 141 which applies a force to the lever 124 (overcoming the forces of the springs 128) and moves the lever 140 into a horizontal position (e.g., relative to an axis defined by the cable seal lock 100). When the lever 124 is in the horizontal position, the tamper pin 132 that extends from the lever 124 contacts and/or penetrates the tamper detector 130.

In an embodiment, the pin 126 shown in FIG. 4A may be used to secure the lever 124 in place in the untampered-with position prior to use of the cable seal lock 100. In an embodiment, the user removes the pin 126 upon using (e.g., closing or locking) the cable seal lock 100.

In an embodiment, the tamper detector 130 is operatively connected to the signal sensing unit 134 (as described below in more detail).

### Electrical Sensing Device

As described above in FIGS. 3, 4A, and 4B, the cable seal lock 100 comprises an electrical sensing device 122. In an example, the electrical sensing device 122 functions as a sensor which is comprised of a flexible wire-shaped material and is partially disposed within the cable wire 118. The electrical sensing device 122 comprises a sensor capable of detecting whether an individual has tampered with the device. Specifically, the electrical sensing device 122 is capable of detecting and acquiring data relating to the application of pressure to the wire 118 and/or the sensing device 122, the application of heat to the wire 118 and/or the sensing device 122, whether the wire 118 and/or the sensing device 122 have been cut or otherwise damaged, and so on. In an example, one end of the electrical sensing device 122 is connected (e.g., mechanically and/or electrically) to a signal sensing unit 134.

In some examples described below in more detail, the sensing device 122 is comprised of a flexible printed circuit that is electrically coupled to the signal sensing unit 134 and extends from the signal sensing unit 134 along at least a part of the length of the wire 118 (e.g. along and adjacent to an internal steel wire of the cable wire 118, such as between the steel wire and an external coating, insulation layer, heat shrink wrapping, etc.). In these examples, the signal sensing unit 134 may correspond to an RFID system configured to indicate a tampered-with state in response to the cable wire 118 being cut. In other examples, the sensing device 122 is comprised of a single sensing wire or conductive thread embedded within the steel wire. In these examples, the signal sensing unit 134 may correspond to a Bluetooth or other circuitry configured to sense when the cable wire 118 is cut, thereby cutting the sensing wire. In each of these examples, the sensing device 122 is single-ended (i.e., the sensing device is electrically coupled to the signal sensing unit 134 or other internal circuitry at only one end of the cable wire 118).

### Signal Sensing Unit

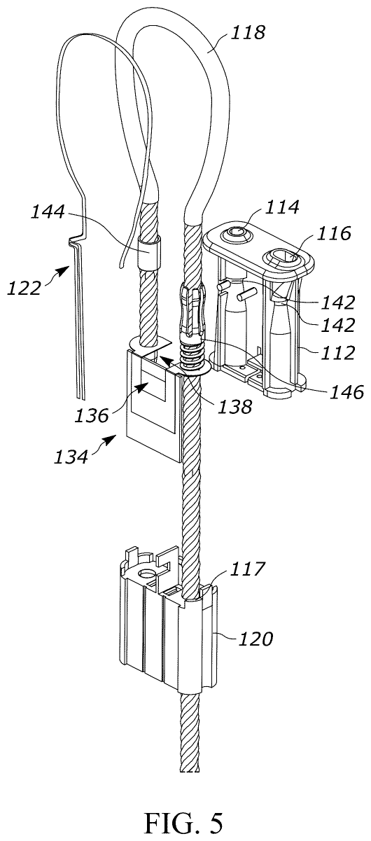

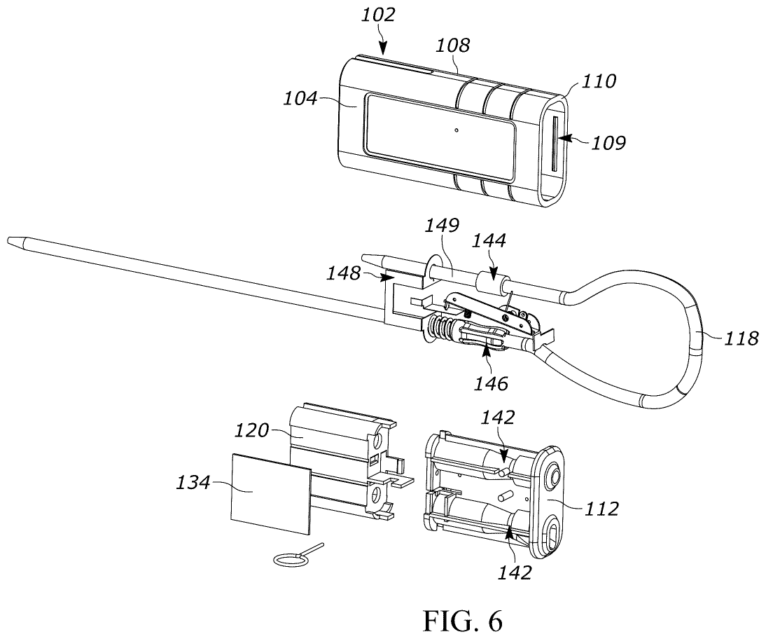

FIGS. 5 and 6 depict the signal sensing unit 134 configured to read data acquired by the electrical sensing device 122. As shown in FIG. 5, the electrical sensing device 122 is comprised of a flexible printed circuit. The electrical sensing device 122 acquires data and relays the data to the signal sensing unit 134. In the embodiment shown, the signal sensing unit 134 comprises an RFID system. The signal sensing unit 134 is comprised of a substrate 136 and a conductive device 138. In the embodiment, shown, the substrate 136 corresponds to an inlay 148 which is disposed partially between the interior body 112 and the base housing 120 and partially proximate a face of the base housing 120. The inlay 148 comprises holes for both the first opening 114 and the second opening 116 passageways and is operatively connected to the electrical sensing device 122 to relay readings from the electrical sensing device 122 to the conductive device 138.

The substrate 136 (e.g., the inlay 148) may be made of BoPET or other similar material and includes two holes 149 for the cable wire 118. The conductive device 138 may be made from any type of conductive material. In the embodiment shown, the conductive device 138 is comprised of the wire 118 and material between the two holes in the inlay 148 (which forms a loop).

In an embodiment, the signal sensing unit 134 (e.g., the inlay 148) is partially disposed along a face of the base housing 120 and the electrical sensing device 122 is operatively connected to the inlay 148.

In another embodiment, the signal sensing unit 134 may comprise BLE circuitry (as described below in more detail), including a circuit board and BLE chip configured to communicate with a wireless device and alert a controller or other computing device of the status of the cable seal lock 100.

In an embodiment, the electrical sensing device 122 communicates information regarding the status of the cable wire 118 (such as whether the cable wire 118 has been heated, cut, etc.) to the signal sensing unit 134, which transmits the information to a wireless device (e.g., via RFID or BLE communication). At the same time, the signal sensing unit 134 obtains information from the tamper detector 130 (such as whether the cable seal lock 100 has entered into the tampered-with position), and transmits the information acquired from the tamper detector 130 to the wireless device.

In another embodiment, the cable seal lock 100 does not comprise an electrical sensing device 122. Instead, the signal sensing unit 134 may acquire information solely from the tamper detector 130.

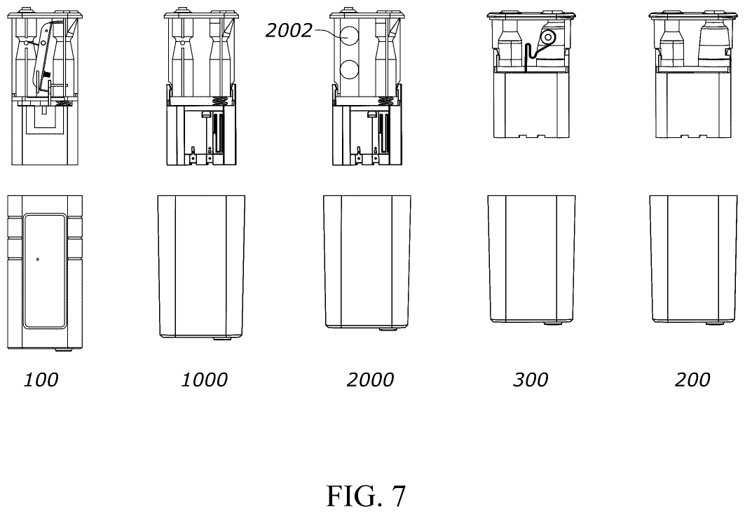

FIG. 7 shows various embodiments of the cable seal lock, such as the cable seal lock 100 described above and cable seal locks 200, 300, 1000, and 2000. For example, the cable seal lock comprises each of the same elements as the first embodiment of the cable seal lock 100 unless described below.

Specifically, the fourth embodiment of the cable seal lock 1000 does not comprise a lever 124, a pin 126, a tamper pin 132, tamper detector 130, or wedge 141.

In an embodiment, the cable seal lock 1000 comprises the electrical sensing device 122, which communicates with the signal sensing unit 134 and transmits the information to a wireless device via RFID or BLE communication.

Conversely, the cable seal lock 2000 comprises each of the elements as first embodiment 100, except that the cable seal lock 2000 does not comprise a plug 144. Instead of the plug 144, the cable seal lock 2000 includes a pair of set screws 2002 to secure the cable wire 118 in place within the first opening 114. In addition, the fifth embodiment the cable seal lock 2000 does not comprise a lever 124, a pin 126, a tamper pin 132, tamper detector 130, or wedge 141. In an embodiment, the cable seal lock 2000 comprises the electrical sensing device 122, which communicates with the signal sensing unit 134 and transmits the information to a wireless device via RFID or BLE communication.

### Second Embodiment of Cable Seal Lock

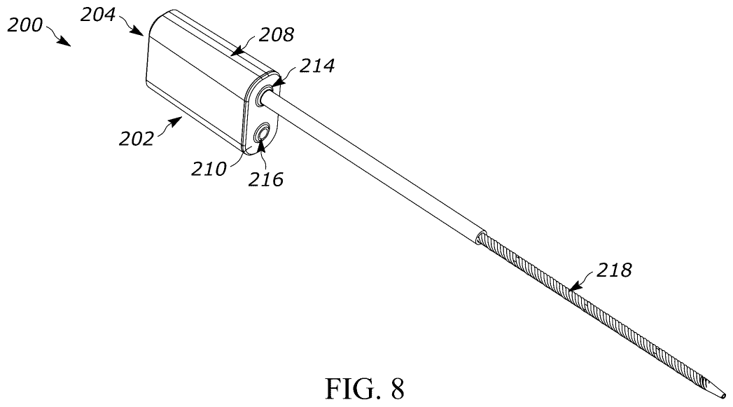

FIGS. 8-10 depict a second embodiment of a cable seal lock 200 (as shown generally in FIG. 7) in more detail. Unless noted herein, similarly labeled elements reflect elements providing similar function to the first embodiment of the cable seal lock 100 described above (e.g., 109, 209 each describe a sleeve, respectively).

The cable seal lock 200 may include a housing 202, a cable wire 218, an electrical sensing device 222, and a signal sensing unit 234. Each of these components is described further in the paragraphs below.

### Housing

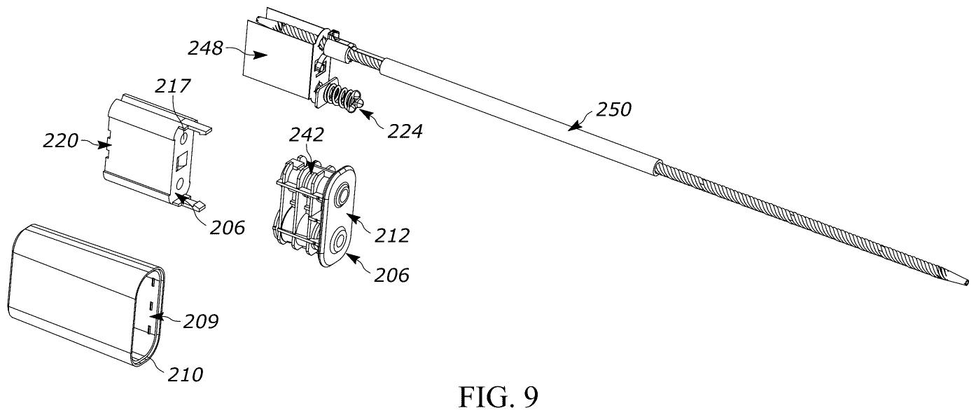

FIGS. 8 and 9 depict an embodiment of a housing 202 of the cable seal lock 200 which may include a bottom end 204 and side walls or sidewalls 208 that cooperatively define a sleeve 209 having an open or top end 210 and an insert assembly 206.

The insert assembly 206 may include an interior body 212 and a base housing 220 that are snap-fit together and disposed within the sleeve 209. When assembled, an inner end of the interior body 212 is contiguous with an outer end of the base housing 220 and the inner end of the base housing 220 is disposed adjacent the first end 204. An outer end of the interior body 212 may extend from the sleeve 209 to close the open end of the sleeve 209 when connected to the housing 202.

The interior body 212 may include a first opening 214 and a second opening 216 which are each formed in the outer end of the interior body 212 and extend through the interior body 212 to define a passageway. The base housing 220 likewise includes a pair of passageways that are aligned with the first and second openings 214, 216.

In an embodiment the first opening 214 and second opening 216 extend straight through the interior body 212 and base housing 220. In another embodiment, the second opening 216 may include a lead-in ramp proximate the top end of the housing 202 including a wall of the lead-in ramp having approximately a 45 degree angle so that the opening 216 has a generally oval configuration. The lead-in ramp facilitates insertion of a cable 218 and disposition of the cable 218 to enable functionality of the cable seal lock 200.

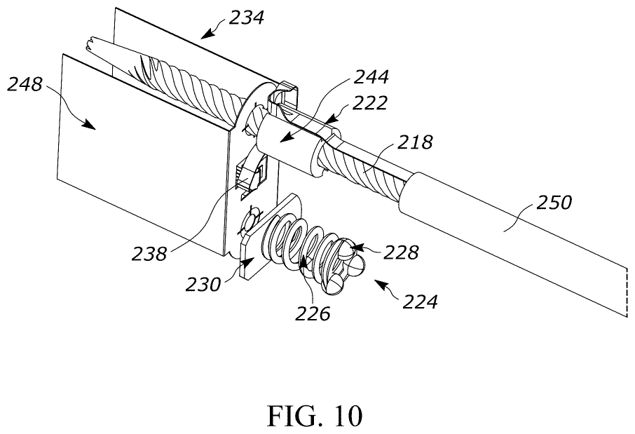

FIG. 10 depicts the internal components disposed within the interior body 212. As shown in FIG. 10, the internal components comprise a spring assembly 224, wherein the spring assembly 224 comprises a support 230 detachably connectable to grooves within the passageway of the second opening 216 proximate the base housing 120. The support 230 is attached to one end of a spring 226 having a plurality of die casting balls 228 along the opposite end. The entirety of the spring assembly 224 may be disposed within the passageway of the second opening 216. When the wire 218 is directed through the second opening 216 (and through the spring assembly 224), the spring assembly prevents the wire 218 from being removed from the second opening 216.

The cable housing 220 comprises first and second openings 217. In an embodiment, the cable housing 220 is disposed flush with the interior body 212 such that the openings 217 of the cable housing 220 and the openings 214, 216 of the interior body 212 are aligned.

The cable wire 218 is disposed within the housing 202. In an embodiment, a first end of the cable wire 218 is secured within a first one of the openings 217 of the base housing 220. The wire 218 extends through the first opening 214 of the interior body 112. An operator manipulates the wire 218 to form a U-shape which redirects the wire 218 back into the second opening 216 of the interior body 212, through a second one of the openings 217 of the base housing 220, and out the bottom end 204 of the housing 202.

In an embodiment, the passageway of the first opening 214 of the interior body 212 comprises a catch 242 (as shown in FIG. 9) and the portion of the wire 218 proximate the passageway of the first opening 214 is securely fastened to a plug 244 (as shown in FIG. 10). In the event that the wire 218 becomes detached from the base housing 220, the catch 242 and plug 244 will prevent the wire 218 from being removed from the cable seal lock 200 via the first opening 214. Specifically, the plug 244 will be unable to pass through the catch 242 within the interior body 212.

In an embodiment, passageway of the second opening 216 of the interior body 212 may similarly comprise the catch 242 and the spring assembly 224 will prevent the wire 218 from being removed from the cable seal lock 200 via the second opening 216. Specifically, the wire 218 and spring assembly 224 will be unable to pass through the catch 242 within the interior body 212.

In an embodiment, a cover 250 may be wrapped around a portion of the cable wire 218 to provide added protection to the cable wire 218 and the electrical sensing device 222 (described below in more detail).

### Electrical Sensing Device

In an embodiment depicted in FIG. 10, the cable seal lock 200 comprises an electrical sensing device 222. The electrical sensing device 222 corresponds to a sensor which is comprised of a flexible wire shaped material (e.g., a flexible printed circuit) and is partially disposed along the cable wire 218. The electrical sensing device 222 comprises a sensor configured to detect whether an individual has tampered with the device. Specifically, the electrical sensing device 222 is configured to detect and acquire data relating to the application of pressure to the wire 218 and sensing device 222, the application of heat to the wire 218 and sensing device 222, whether the wire 218 and/or sensing device 222 have been cut or otherwise damaged, and so on.

In an embodiment, one end of the electrical sensing device 222 is connected to the signal sensing unit 234 (described below in more detail). The electrical sensing device 222 is arranged between the cable wire 218 and the cover 250. Cutting or otherwise damaging the wire 218 will result in irreparable damage to the flexible printed circuit. In other words, attempting to repair or reconnect the cable wire 218 to conceal the fact that the cable wire 218 was cut will not result in repair of the electrical sensing device 222. Accordingly, upon any cutting of the wire 218, the signal sensing unit 234 will indicate the tampered-with state regardless of any subsequent attempts to repair the wire 218.

### Signal Sensing Unit

FIG. 10 further depicts the signal sensing unit 234 configured to read data acquired by the electrical sensing device 222. The electrical sensing device 222 acquires data and relays the data to the signal sensing unit 234. In the embodiment shown, the signal sensing unit 234 comprises an RFID system. The signal sensing unit 234 is comprised of a substrate 236 and a conductive device 238. In the embodiment shown, the substrate 236 corresponds to an inlay 248 which is disposed partially between the interior body 212 and base housing 220 and partially proximate a face of the base housing 220. The inlay 248 comprises holes for both the first opening 214 and the second opening 216 passageways and is operatively connected to the electrical sensing device 222 to relay readings from the electrical sensing device 222 to the conductive device 238.

The substrate 236 (inlay 248) may be comprised of BoPET or other similar material and includes two holes for the cable wire 218. The conductive device 238 may be made from any type of conductive material. In the embodiment shown, the conductive device 238 is comprised of the wire 218 and material between the two holes in the inlay 248 (which forms a loop).

In an embodiment, the signal sensing unit 234 (inlay 248) is partially disposed along a face of the base housing 220 and the electrical sensing device 222 is operatively connected to the signal sensing unit 234 via the inlay 248.

In an embodiment, the signal sensing unit 134 may comprise BLE circuitry (described below in more detail), including a circuit board and BLE chip configured to communicate with a wireless device and alert a controller or other computing device of the status of the cable seal lock 200.

In an embodiment, the electrical sensing device 222 communicates information regarding the status of the cable wire 218 (such as whether the cable wire 118 has been heated or cut) to the signal sensing unit 234, which transmits the information to a wireless device via RFID or BLE communication.

### Third Embodiment of the Cable Seal Lock

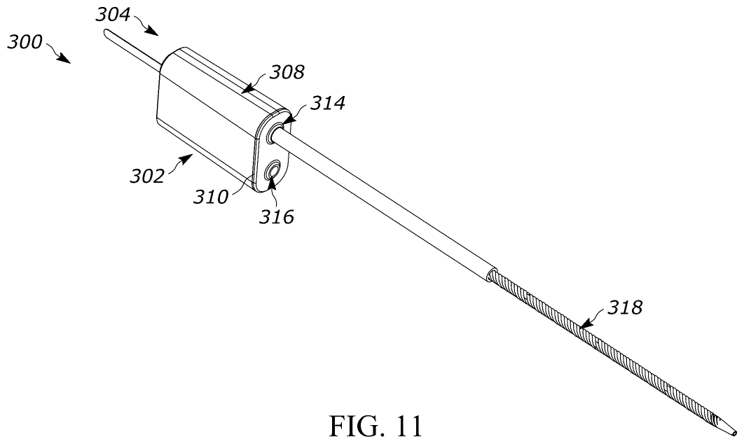

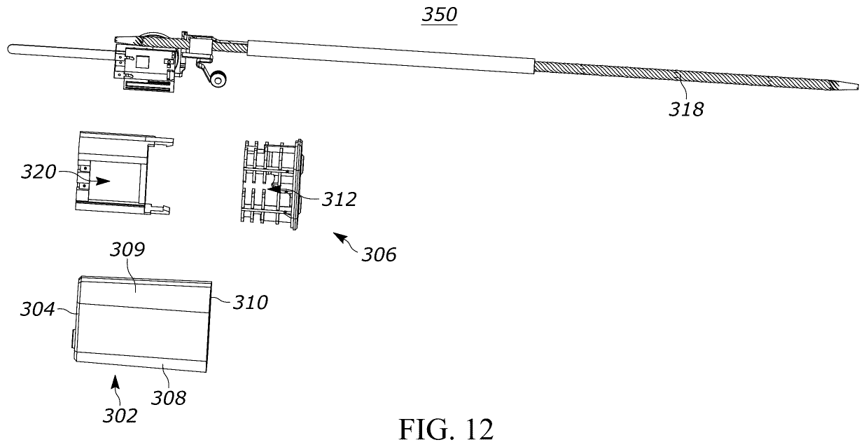

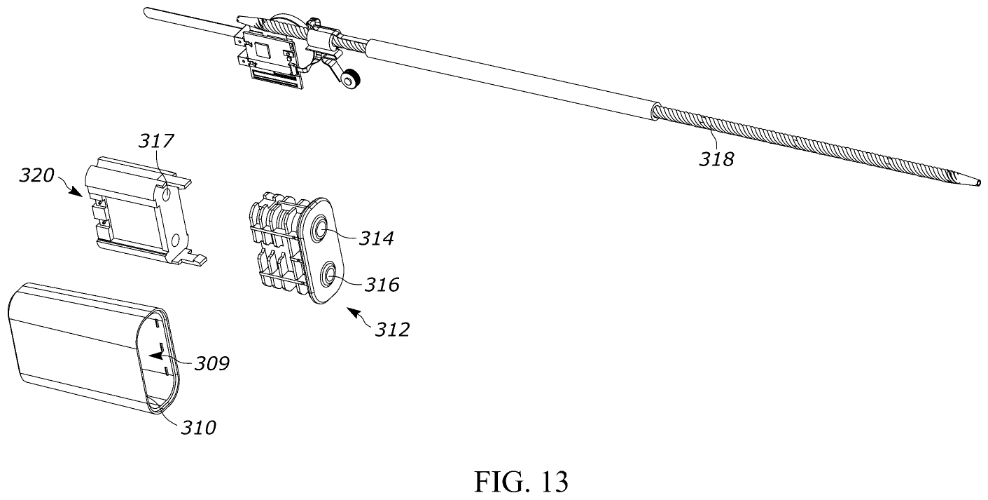

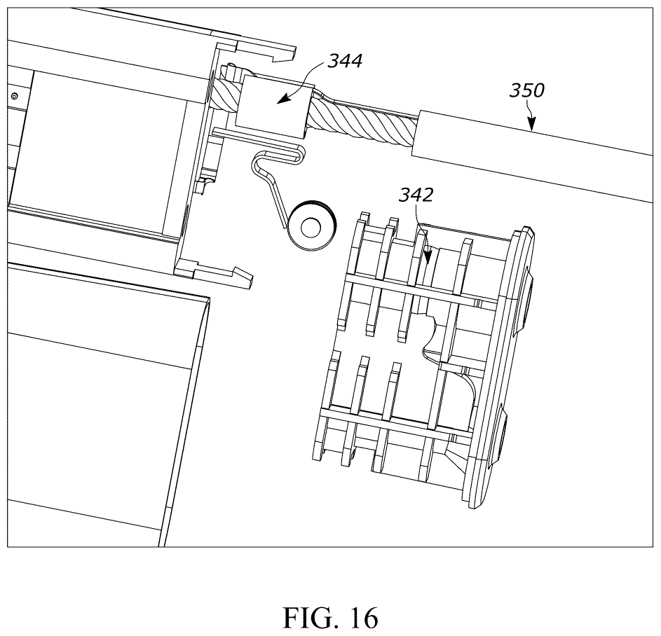

FIGS. 11-16 depict a third embodiment of a cable seal lock 300 (as shown generally in FIG. 7). Unless noted herein, similarly labeled elements reflect elements providing similar function to the second embodiment of the cable seal lock 200 described above (e.g., 209, 309 each describe a sleeve respectively).

The cable seal lock 300 may include a housing 302, a cable wire 318, an electrical sensing device 322, and a signal sensing unit 334. Each of these components are described further in the paragraphs below.

### Housing

FIG. 11-13 depict an embodiment of a housing 302 of the cable seal lock 300 which may include a bottom end 304 and a side wall or sidewall 308 that cooperatively define a sleeve 309 having an open or top end 310 and an insert assembly 306.

The insert assembly 306 may include an interior body 312 and a base housing 320 that are snap-fit together and disposed within the sleeve 309. When assembled, an inner end of the interior body 312 is contiguous with an outer end of the base housing 320 and the inner end of the base housing 320 is disposed adjacent the first end 304. An outer end of the interior body 312 may extend from the sleeve 309 to close the open end of the sleeve 309 when connected to the housing 302.

The interior body 312 may include a first opening 314 and a second opening 316 which are each formed in the outer end of the interior body 312 and extend through the interior body 312 to define a passageway. The base housing 320 likewise includes a pair of passageways that are aligned with the first and second openings 314, 316.

In an embodiment the first opening 314 and second opening 316 extend straight through the interior body 312 and base housing 320. In another embodiment, the second opening 316 may include a lead-in ramp proximate the top end 310 of the housing 302 including a wall of the lead-in ramp having approximately a 45 degree angle so that the opening 316 has a generally oval configuration. The lead-in ramp facilitates insertion of a cable 318 and disposition of the cable 318 to enable functionality of the cable seal lock 300.

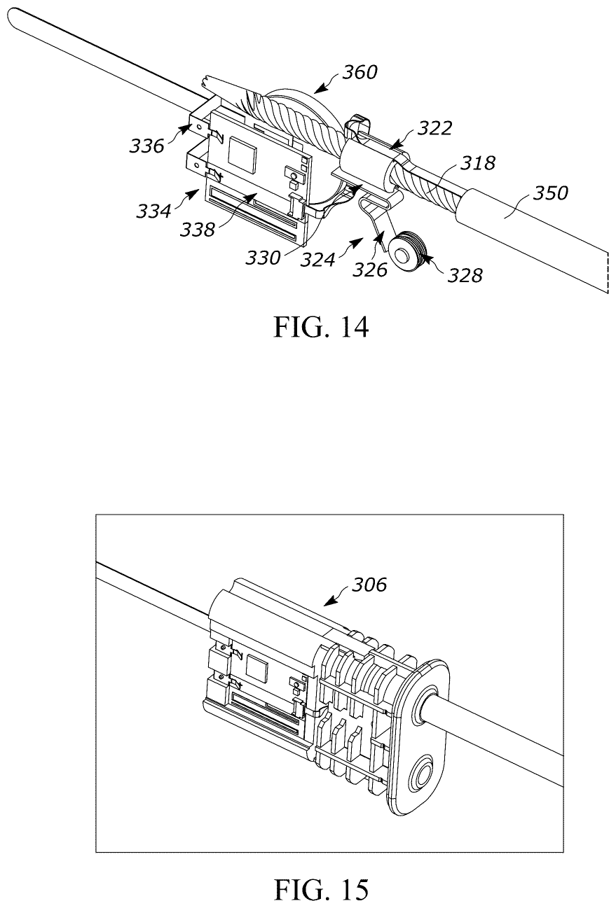

FIG. 14 depicts internal components disposed within the interior body 312. As shown in FIG. 14, the internal components comprise a spring assembly 324, wherein the spring assembly 324 comprises a support beam 330 connected to and extending from the interior body 312. In an embodiment, the support beam 330 comprises a double U-turn shape disposed within the interior body 312. Extending from the support beam 330 is a biasing element such as a spring 326 operatively connected with a rotatable disc 328 attached proximate the end of the spring 326. The spring 326 and rotatable disc 328 may be disposed within the passageway of the second opening 316. When the cable wire 318 is directed through the second opening 316, the spring assembly 324 prevents the cable wire 318 from being withdrawn from the second opening 316.

In an embodiment, the rotatable disc 328 is comprised of a metal or other hard material. The rotatable disc 328 comprises grooves in the shape of gear teeth which interact with the spring 326. The grooves ensure that the disc 328 can rotate in a single direction. When the wire 318 is inserted into the second opening 316, the disc 328 rotates as the wire 318 moves through the interior body 312. However, when a user attempts to withdraw the wire 318 from the second opening 316, the disc 328 does not rotate and prevents the wire 318 from being withdrawn.

FIGS. 11-13 depict the cable housing 320. The cable housing 320 comprises a first opening and a second opening. In an embodiment, the cable housing 320 is disposed flush with the interior body 312 such that openings 317 of the cable housing 320 and openings 314, 316 of the interior body 312 are aligned.

A cable wire 318 is disposed within housing 302. In an embodiment, a first end of the cable wire 318 is secured within a first one of the openings 317 of the base housing 320. The wire 318 extends through the first opening 314 of the interior body 312. An operator manipulates the wire 318 to form a U-shape which redirects the wire 318 back into the second opening 314 of the interior body 312, through a second one of the openings 317 of the base housing 320, and out the bottom end 304 of the housing 302.

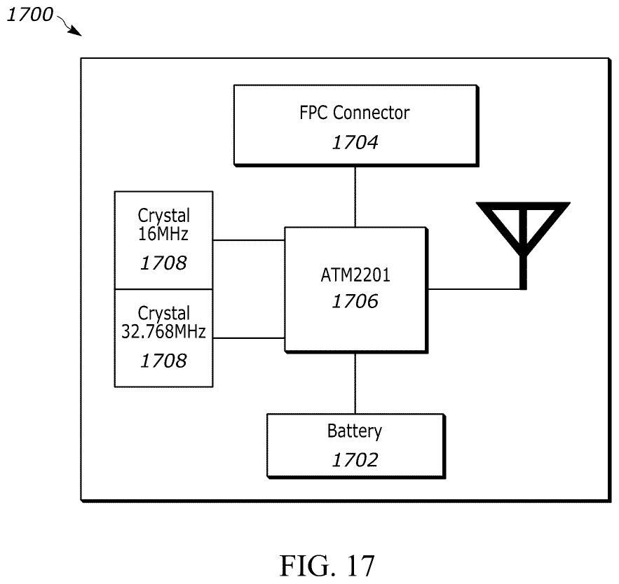

In an embodiment shown in FIG. 16, the passageway of the first opening 314 of the interior body 312 comprises a catch 342 and the portion of the wire 318 proximate the passageway of the first opening 314 is securely fastened to a plug 344. In the event that the wire 318 becomes detached from the base housing 320, the catch 342 and plug 344 will prevent the wire 318 from being removed from the cable seal lock 300 via the first opening 314. Specifically, the plug 344 will be unable to pass through the catch 342 within the interior body 312.

In an embodiment, the passageway of the second opening 316 of the interior body 312 may similarly comprise a catch 342 and plug assembly. In another embodiment, the spring assembly 324 will prevent the wire 318 from being removed from the cable seal lock 300 via the second opening 316. Specifically, the wire 318 cannot pass around the spring assembly 324 which provides a barrier to exiting the second opening 316 of the interior body 312.

In an embodiment, a cover 350 may be wrapped around a portion of the cable wire 318 to provide added protection to the cable wire 318 and the electrical sensing device 322 (as described below in more detail).

### Electrical Sensing Device

In an embodiment, and as depicted in FIG. 14 the cable seal lock 300 comprises an electrical sensing device 322. The electrical sensing device 322 corresponds to a sensor which is comprised of a flexible wire shaped material (in this example, a flexible printed circuit) and is partially disposed along the cable wire 318, between the cable 318 and the cover 350. The electrical sensing device 322 comprises a sensor configured to detect whether an individual has tampered with the device. Specifically, the electrical sensing device 322 is configured to detect and acquire data relating to the application of pressure to the wire 318 and sensing device 322, the application of heat to the wire 318 and sensing device 322, whether the wire 318 and sensing device 322 have been cut or otherwise damaged, and so on.

In an embodiment, one end of the electrical sensing device 322 is connected to the signal sensing unit 334 (as described below in more detail).

### Signal Sensing Unit

FIG. 14 depicts a signal sensing unit 334 configured to read data acquired by the electrical sensing device 322. The electrical sensing device 322 acquires data and relays the data to the signal sensing unit 334, which is comprised of a platform 336 and a conductive device 338 (which, as shown in this embodiment, may correspond to a circuit board).

The conductive device 338 is disposed along a face of the base housing 320 and is operatively connected to the electrical sensing device 322 to relay measurements from the electrical sensing device 322 to a BLE chip or circuitry 360.

In an embodiment, the conductive device 338 is operatively connected to the BLE chip 360, which is configured to communicate with a wireless device to alert a controller or other computing device of the status of the cable seal lock 300.

In an embodiment, the electrical sensing device 322 communicates information regarding the status of the cable wire 318 (such as whether the cable wire 118 has been heated or cut) to the signal sensing unit 334, which transmits the information to a wireless device via either of RFID or BLE communication.

### Operation of RFID and BLE

As described above, the conductive device 138, 238, 338 is operatively connected to an RFID or BLE chip (or other suitable near field wireless communication circuitry) to communicate with a wireless device and alert a controller or other computing device of the status of the cable seal lock 100, 200, 300.

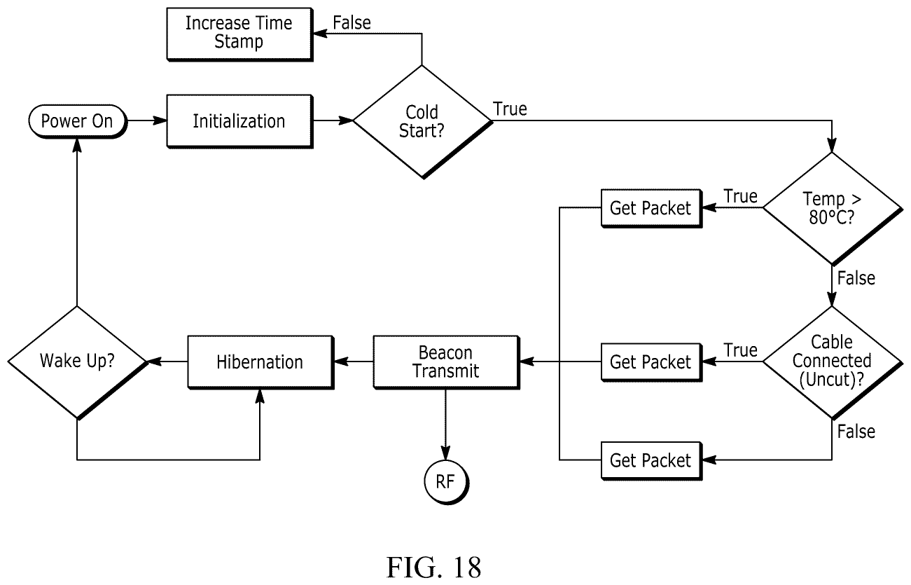

FIG. 17 depicts a BLE chipset 1700 implemented within the cable seal lock 100, 200, 300, etc. of the present disclosure. The BLE chipset 1700 comprises a battery 1702, a Flexible Printed Circuit (FPC) connector 1704, a processor or processing device (e.g., a BLE chip, such as an ATM2201 chip) 1706, and two crystals 1708 for tuning and clock management.

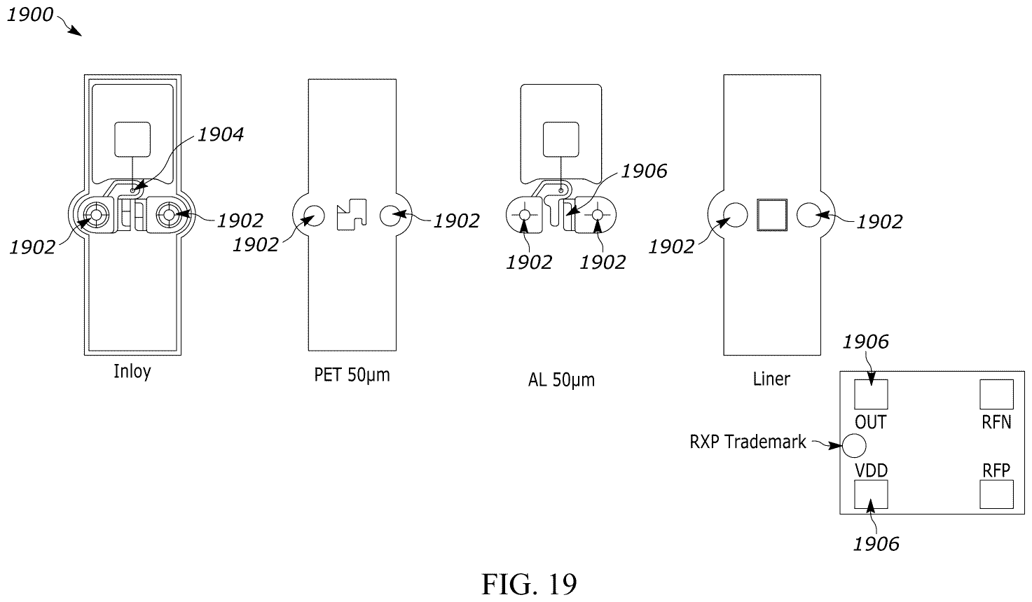

FIG. 18 depicts an example flow diagram of the functionality of the BLE chipset 1700. A standard BLE chipset 1700 may be powered on, powered off, or set in a hibernated state. When the BLE chipset 1700 is powered on (or cold booted from a hibernated state), the BLE chipset 1700 will adjust its timestamp automatically and begin advertising the information received from the signal sensing unit 134, 234, 334 and conductive device 138, 238, 338 (including, battery voltage, cable 118, 218, 318 temperature, whether the cable 118, 218, 318 has been cut, etc.). For example, the end of the sensing device 122, 222, 322 connected to the signal sensing unit 134, 234, 334 (e.g., the BLE chipset 1700) may be electrically coupled to a terminal of the battery 1702. Accordingly, cutting of the cable 118, 218, 318 will cause a sensed electrical characteristic of the sensing device 122, 222, 322 to change, which is detected by the signal sensing unit 134, 234, 334.

Where the BLE chipset 1700 finds that the temperature of the cable 118, 218, 318 is above a set temperature (such as 80 degrees Celsius), the BLE chipset 1700 will transmit a signal to a wireless device and alert the controller to the status of the cable seal lock 100, 200, 300.

If the temperature is below a set temperature, the BLE chipset 1700 transitions to the next step and determines whether the cable 118, 218, 318 has been cut. Where the BLE chipset 1700 finds that the cable 118, 218, 318 has been cut, the BLE chipset 1700 will transmit a signal to a wireless device and alert the controller to the status of the cable seal lock 100, 200, 300. If the cable 118, 218, 318 is not cut, the BLE chipset 1700 will transmit a signal to a wireless device to inform the controller or other computing device of the status of the cable seal lock 100, 200, 300. This cycle may be continuous until the BLE chipset 1700 enters hibernation mode or is powered off.

The BLE chipset 1700 described above may be used in connection with any of the embodiments of the cable seal lock 100, 200, 300, 1000, 2000 described above.

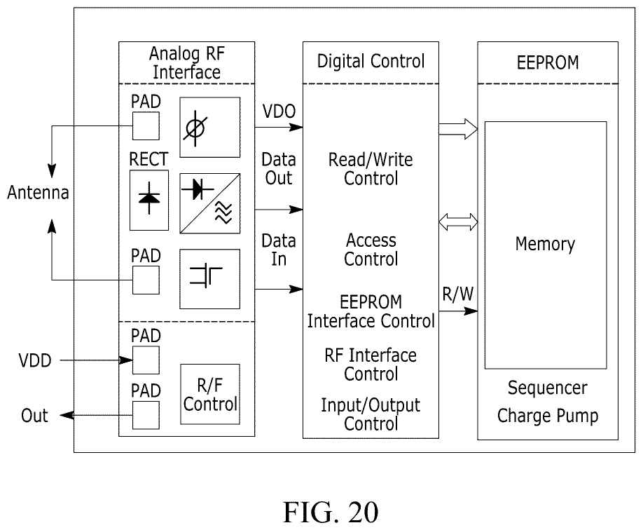

FIG. 19 depicts an example seal inlay 1900 according to the present disclosure. The seal inlay 1900 of FIG. 19 may correspond to a standard seal inlay configured for use with an RFID chip. In some embodiments, the seal inlay 1900 may be used with the BLE chipset 1700. The seal inlay 1900 comprises two holes 1902 aligned with the openings (such as 116, 216, 316, 114, 214, 314 through which the cable 118, 218, 318 passes). Along the center of the seal inlay 1900 is the RFID chip 1904 proximate two contact points/pads 1906. A conductive device connects at both holes (such as the cable wire 118, 218, 318) proximate the RFID chip 1904 and two pads 1906 to form an antenna configured to send a signal. The seal inlay described herein may be used in connection with the cable seal lock 100, 200, 300, 1000, 2000 to send a signal regarding the status (e.g., open, closed, or tampered with) of the cable seal lock 100, 200, 300, 1000, 2000 to a controller or other computing device.

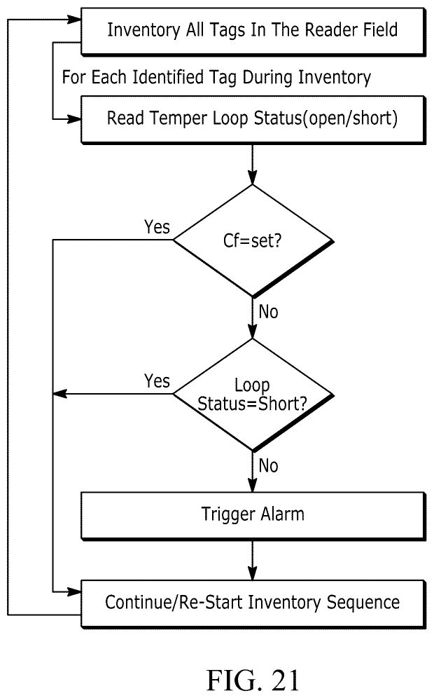

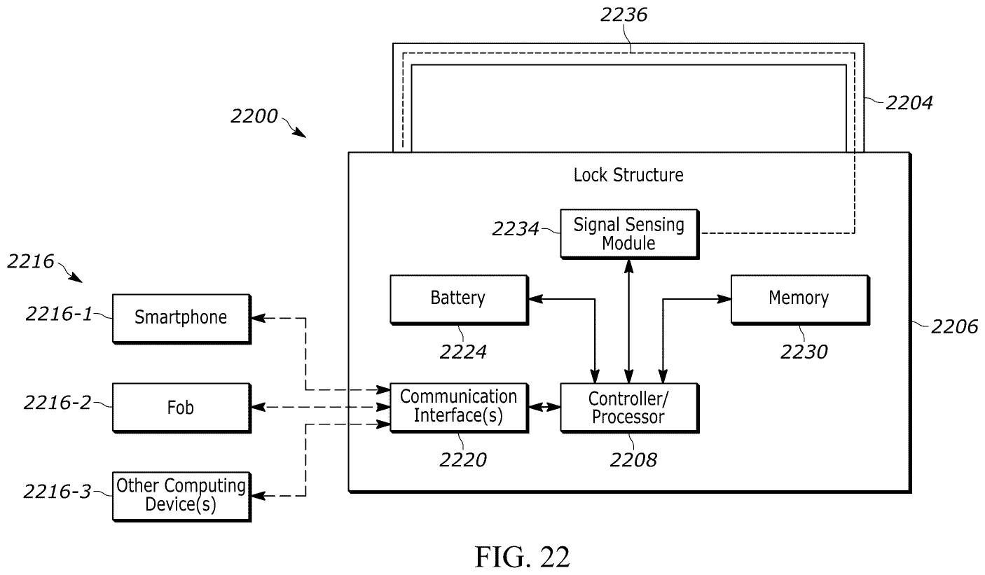

FIG. 20 depicts an example schematic of a standard RFID system configured to be implemented by the cable seal lock of the present disclosure and FIG. 21 depicts an example flow diagram of the RFID system. In the preferred embodiment, a user scans the RFID chip which activates the RFID chip. The activated RFID chip broadcasts a current state of the cable 118, 218, 318 (such as the temperature of the cable 118, 218, 318 whether or not the cable 118, 218, 318 has been cut, etc.) to a wireless device to alert the controller or other computing device of the status of the cable seal lock 100, 200, 300. If either the temperature is above a set temperature (such as 80 degrees Celsius) or the cable 118, 218, 318 is cut, the RFID chip may instruct the wireless device to trigger an alarm to alert the controller.

In the preferred embodiment, the RFID system broadcasts the current state of the cable seal lock 100, 200, 300, 1000, 2000 as being open, closed, or tampered with.

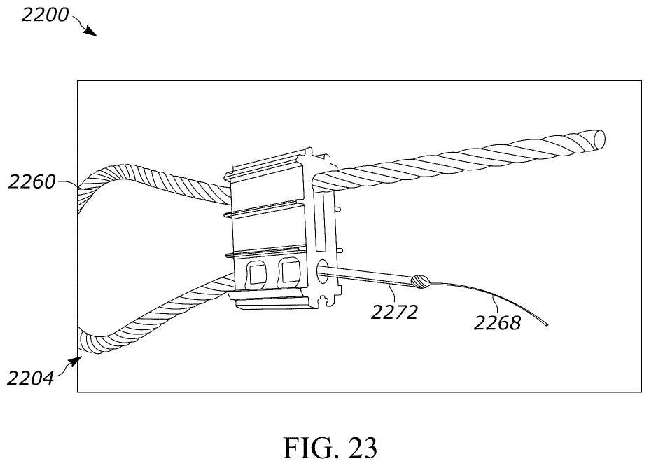

FIG. 22 shows a functional block diagram of an example lock structure, such as a cable seal lock 2200, according to the present disclosure (e.g. corresponding to the cable seal locks described herein). The cable seal lock 2200 includes a locking mechanism 2204, such as a cable wire, and a housing 2206 enclosing various components. The cable seal lock 2200 includes a controller, processor, or other control circuitry 2208 configured to control and communicate with various components of the cable seal lock 2200. In some examples, the controller 2208 may include and/or implement RFID or Bluetooth control circuitry as described herein.

Cable seal lock 2200 may be responsive to and/or provide status and other information to various computing devices external to the cable seal lock 2200. In some examples, cable seal lock 2200 may be configured to communicate with RFID, BLE, and/or other near-field devices. In other examples, the cable seal lock 2200 may be configured to communicate with other types of computing devices including, but not limited to, a smartphone 2216-1, a control fob 2216-2, and/or one or more other computing devices 2216-3, referred to collectively as computing devices 2216. The devices external to the cable seal lock 2200 may be local (e.g., located within short-range wireless communication range, such as communication ranges associated with Bluetooth communication, wireless communication, RFID communication, BLE communication, etc.) or remote (e.g. located outside of short-range wireless communication ranges, such as communication ranges associated with cellular communication, satellite communication, etc.). The cable seal lock 2200 is configured to communicate with the various computing devices 2216 via one or more respective communication interfaces 2220, which may include, but are not limited to, a Bluetooth (e.g., BLE) interface, an RFID interface, a cellular (e.g., LTE) interface, and/or other wireless or wired communication interfaces. When configured to communicate via a cellular interface, the lock structure may include a SIM card and/or interface (not shown). In some examples, the communication interfaces 2220 may include a GPS or other satellite navigation system interface.

The cable seal lock 2200 may include and receive electrical power from a rechargeable battery (e.g., a rechargeable lithium ion battery) 2224. The battery 2224 may be rechargeable via a wired or wireless charging interface (not shown). In some examples, the battery 2224 is chargeable via solar power, such as solar power received via one or more solar panels arranged on the lock structure (not shown).

The cable seal lock 2200 may include memory 2230 corresponding to one or more memory devices, circuitry, etc., such as volatile memory, non-volatile memory, etc. The memory 2230 may be configured to store executable code (e.g., executable by the controller 2208), information associated with the cable seal lock 2200, and/or status information (e.g., status information regarding status changes to the cable seal lock 2200 during transit, detected locking, locking, and tampered with states, etc.).

The cable seal lock 2200 according to the present disclosure further includes various mechanisms for detecting whether the cable seal lock 2200 is tampered with as described above in more detail. For example, the cable seal lock 2200 includes a signal sensing module 2234 electrically coupled to an electrical sensing device 2236 enclosed within the locking mechanism 2204. For example, the electrical sensing device 2236 may include a wire or other conductive element (e.g., a flexible printed circuit, conductive trace, etc.) enclosed within a cable wire. In an example, the electrical sensing device 2236 is separate from (e.g., comprised of a different material, structure, etc. than) the locking mechanism 2204. In other words, the electrical sensing device 2236 is not comprised of the locking mechanism 2204 and vice versa. Rather, the electrical sensing device 2236 is a separate component enclosed by the locking mechanism 2204. In some examples, the electrical sensing device 2236 is electrically insulated from the locking mechanism 2204.

The signal sensing module 2234 is configured to detect tampering with the locking mechanism 2204 (e.g., by cutting or otherwise damaging the locking mechanism 2204) as described herein. For example, the signal sensing module 2234 includes a substrate and/or circuitry connected to the electrical sensing device 2236 (e.g., via one or more conductive devices, nodes, etc.). As one example, the signal sensing module 2234 is configured to detect whether cutting or other modification of the cable wire caused the cable wire to change from an untampered-with position to a tampered-with position as described above.

As described herein, the cable seal lock 2200 of the present disclosure may be configured to operate with various wireless communication technologies to facilitate collection of data and monitoring of the status of the cable seal lock 2200.

BLE functionality as described herein is not limited to over-the-air updates and controls but instead may operate as a mesh network of sensors (e.g., temperature, humidity, pressure, G orientation sensors, a security camera, etc.). A BLE network may support smart synchronization of radios to facilitate data collection, such as GPS and LTE location tracking, thus enabling the system to report more accurate detailed pinpoints during shipments.

In various examples, the cable seal lock 2200 is configured to use BLE, cellular radios, and/or other communication systems to sense and interact with computers and smart phones for secure, reliable, and safe lock/unlock operations. The cable seal lock 2200 may be configured to implement intelligent monitoring of in-range devices to distinguish friendly vs hostile attacks such as illegal trackers, jammers, and sniffing devices used to attempt to breach a security seal. These and other early detection methods allow notification signals to be sent prior to wireless saturation occurring.

Accordingly, the cable seal lock 2200 can include mechanical, software, and electrical tamper detection techniques within the same housing 2206. This design approach increases the security level relative to other solutions.

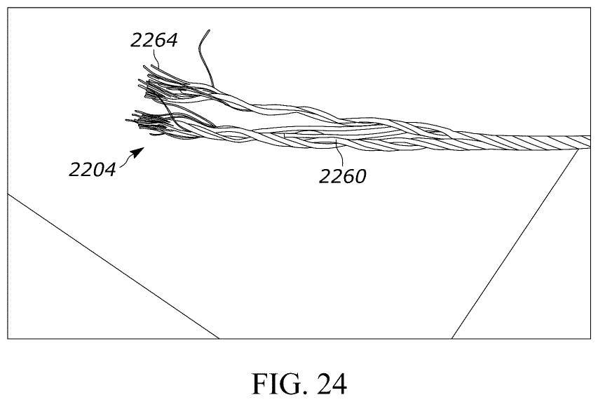

FIGS. 23 and 24 show an example of the locking mechanism 2204 implemented as a wire rope or cable wire (e.g., a steel braided or twisted wire) 2260. In this example, the cable wire 2260 is comprised of a plurality of individual strands or wires 2264. The sensing device 2236 is implemented as a single sensing wire 2268 embedded within the cable wire 2260. In some examples, the sensing wire 2268 has a same or approximately same thickness as the wires 2264.

As shown in FIG. 23, the single sensing wire 2268 is enclosed in an insulation layer 2272. In an example, the insulation layer 2272 is substantially transparent. In other examples, the insulation layer 2272 may be non-transparent or opaque but have a same or similar color as the wires 2264. Accordingly, the sensing wire 2268 is insulated from the cable wire 2260 along a substantial portion of the length of the cable wire 2260. However, in some examples, an end of the sensing wire 2268 (e.g., an end of the sensing wire 2268 opposite the end electrically coupled to the signal sensing module 2234) extends beyond the insulating layer 2272 and is in electrical contact with the end of the cable wire 2260. For example, the end of the sensing wire 2268 is shorted to/with the end of the cable wire 2260 (e.g., at an end of the cable wire 2260 that is inserted within the cable seal lock 2200 to lock the cable seal lock 2200). In this manner, cutting the cable wire 2260 anywhere along its length breaks a circuit path formed between the sensing wire 2268 and the cable wire 2260. As one example, shorting the end of the sensing wire 2268 to the end of the cable wire 2260 shorts the sensing wire 2268 to ground.

The sensing wire 2268 is substantially indistinguishable from the wires 2264 of the cable wire 2260. Accordingly, when the cable wire 2260 is cut or otherwise damaged as shown in FIG. 24, the sensing wire 2268 cannot be identified or distinguished from among the wires 2264. As such, it is extremely difficult to repair, solder, etc. the sensing wire 2268 subsequent to cutting or other damage to the cable wire 2260.

In an example, the cable wire 2260 has a diameter between 2.0 and 10.0 mm. In one example, the cable wire 2260 has a diameter of approximately 4.0 mm. In an example, the sensing wire 2268 is comprised of carbon steel. In an example, the sensing wire 2268 has a diameter between 0.1 and 0.5 mm. In an example, the sensing wire 2268 has a diameter of approximately 0.3 mm. In an example, the insulation layer 2272 is comprised of nylon. In an example, the insulation layer 2272 has an outer diameter between 0.7 and 2.0 mm. In an example, the insulation layer 2272 has an outer diameter of approximately 1.5 mm.

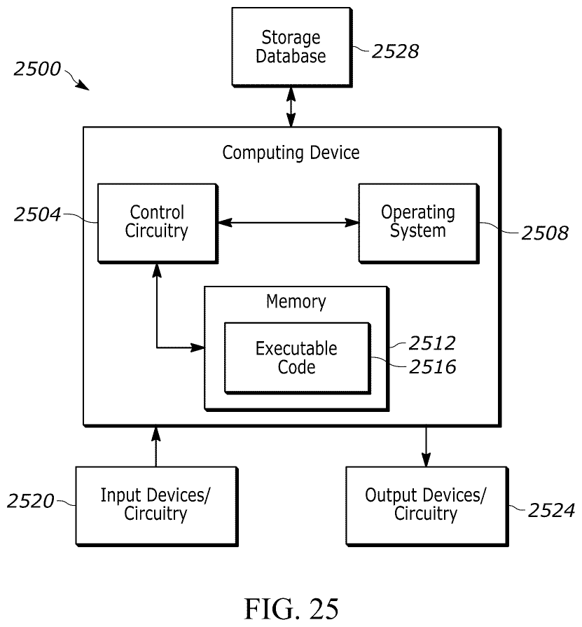

FIG. 25 shows a block diagram of an example computing device 2500 configured to implement functions of the systems and methods described herein according to the present disclosure. For example, one or more of the computing devices 2500 may implement or be implemented by the one or more components of the cable seal lock 2200. Systems described herein may implement a single computing device, a plurality of computing devices, etc., configured to individually and/or collectively perform functions related to the systems and methods of the present disclosure.

The computing device 2500 may include control circuitry 2504 that may be, for example, one or more processors or processing devices, a central processing unit processor, an integrated circuit or any suitable computing or computational device, an operating system 2508, memory 2512, executable code 2516, input devices or circuitry 2520, and output devices or circuitry 2524. The control circuitry 2504 (or one or more controllers or processors, possibly across multiple units or devices) may be configured to implement functions of the systems and methods described herein. More than one of the computing devices 2500 may be included in, and one or more of the computing devices 2500 may act as the components of, a system according to embodiments of the disclosure. Various components of the computing device 2500 may be implemented with same or different circuitry, same or different processors or processing devices, etc.

The operating system 2508 may be or may include any code segment (e.g., one similar to the executable code 2516 described herein) configured and/or configured to perform tasks involving coordination, scheduling, arbitration, supervising, controlling or otherwise managing operation of the control circuitry 2504 (e.g., scheduling execution of software programs or tasks or enabling software programs or other hardware modules or units to communicate). The operating system 2508 may be a commercial operating system. The operating system 2508 may be an optional component (e.g., in some embodiments, a system may include a computing device that does not require or include the operating system 2508). For example, a computer system may be, or may include, a microcontroller, an application specific circuit (ASIC), a field programmable array (FPGA), network controller (e.g., CAN bus controller), associated transceiver, system on a chip (SOC), and/or any combination thereof that may be used without an operating system.

The memory 2512 may be or may include, for example, Random Access Memory (RAM), read only memory (ROM), Dynamic RAM (DRAM), Synchronous DRAM (SD-RAM), a double data rate (DDR) memory chip, Flash memory, volatile memory, non-volatile memory, cache memory, a buffer, a short-term memory unit, a long-term memory unit, or other suitable memory units or storage units. The memory 2512 may be or may include a plurality of memory units, which may correspond to same or different types of memory or memory circuitry. The memory 2512 may be a computer or processor non-transitory readable medium, or a computer non-transitory storage medium, e.g., RAM.

The executable code 2516 may be any executable code, e.g., an application, a program, a process, task, or script. The executable code 2516 may be executed by the control circuitry 2504, possibly under control of the operating system 2508. Although, for the sake of clarity, a single item of the executable code 2516 is shown, a system according to some embodiments of the disclosure may include a plurality of executable code segments similar to the executable code 2516 that may be loaded into the memory 2512 and cause the control circuitry 2504 to carry out methods described herein. Where applicable, the terms “process” and “executable code” may be used interchangeably herein. For example, verification, validation and/or authentication of a process may mean verification, validation and/or authentication of executable code.

In some examples, the memory 2512 may include non-volatile memory having the storage capacity of a storage system. In other examples, the computing device 2500 may include or communicate with a storage system and/or database. Such a storage system may include, for example, flash memory, memory that is internal to, or embedded in, a micro controller or chip, a hard disk drive, a solid-state drive, a CD-Recordable (CD-R) drive, a Blu-ray disk (BD), a universal serial bus (USB) device or other suitable removable and/or fixed storage unit. Content may be stored in the storage system and loaded from the storage system into the memory 2512 where it may be processed by the control circuitry 2504.

The input circuitry 2520 may be or may include any suitable input devices, components, or systems, e.g., physical sensors such as accelerometers, thermometers, microphones, analog to digital converters, etc., a detachable keyboard or keypad, a mouse, etc. The output circuitry 2524 may include one or more (possibly detachable) displays or monitors, motors, servo motors, speakers and/or any other suitable output devices. Any applicable input/output (1/O) devices may be connected to the control circuitry 2504. For example, a wired or wireless network interface card (NIC), a universal serial bus (USB) device, or external storage device may be included in the input circuitry 2520 and/or the output circuitry 2524. It will be recognized that any suitable number of input devices and output devices may be operatively connected to the control circuitry 2504. For example, the input circuitry 2520 and the output circuitry 2524 may be used by a technician or engineer in order to connect to the control circuitry 2504, update software, and the like.

Embodiments may include an article such as a computer or processor non-transitory readable medium, or a computer or processor non-transitory storage medium, such as for example memory, a disk drive, or USB flash memory, encoding, including or storing instructions (e.g., computer-executable instructions, which, when executed by a processor or controller, carry out methods disclosed herein), a storage medium such as the memory 2512, computer-executable instructions such as the executable code 2516, and a controller such as the control circuitry 2504.

The storage medium may include, but is not limited to, any type of disk including magneto-optical disks, semiconductor devices such as read-only memories (ROMs), random access memories (RAMs), such as a dynamic RAM (DRAM), erasable programmable read-only memories (EPROMs), flash memories, electrically erasable programmable read-only memories (EEPROMs), magnetic or optical cards, or any type of media suitable for storing electronic instructions, including programmable storage devices.

Embodiments of the disclosure may include components such as, but not limited to, a plurality of central processing units (CPU) or any other suitable multi-purpose or specific processors or controllers (e.g., controllers similar to the control circuitry 2504), a plurality of input units, a plurality of output units, a plurality of memory units, and a plurality of storage units, etc. A system may additionally include other suitable hardware components and/or software components. In some embodiments, a system may include or may be, for example, a personal computer, a desktop computer, a mobile computer, a laptop computer, a notebook computer, a terminal, a workstation, a server computer, a Personal Digital Assistant (PDA) device, a tablet computer, a network device, or any other suitable computing device.

In some embodiments, a system may include or may be, for example, a plurality of components that include a respective plurality of central processing units, e.g., a plurality of CPUs as described, a plurality of CPUs embedded in an on-board system or network, a plurality of chips, FPGAs or SOCs, microprocessors, transceivers, microcontrollers, a plurality of computer or network devices, any other suitable computing device, and/or any combination thereof. For example, a system as described herein may include one or more devices such as the control circuitry 2504.

The computing device 2500 may include and/or communicate with one or more storage devices or databases 2528. For example, the storage database 2528 may correspond to a storage device (e.g., a semiconductor storage device, such as a solid-state drive (SSD)) of the computing device 2500, a remote storage device or database, a cloud computing system, etc. The storage database 2528 may store data accessible by one or more components of the cable seal lock 2200.

In some examples, the computing device 2500 may implement an artificial intelligence (AI) engine configured to execute one or more AI or machine learning (ML) models, etc. trained using data (“training data”) obtained during operation of the cable seal lock 2200. Various components of the training data, an AI engine, ML models, etc. may be stored within the computing device 2500 or external to the computing device 2500 (e.g., in a remote server, a cloud computing system, etc.).

Unless defined otherwise, all technical and scientific terms used herein have the same meaning as commonly understood by persons having ordinary skill in the art to which the invention pertains. Although any systems, methods, and materials similar or equivalent to those described herein can be used in practice for testing of the present invention, the preferred systems, methods, and materials are described herein.

In understanding the scope of the present invention, the articles “a” and “an” are used herein to refer to one or to more than one (i.e., to at least one) of the grammatical object of the article. By way of example, “an element” means one element or more than one element. The term “comprising” and its derivatives, as used herein, are intended to be open ended terms that specify the presence of the stated features, elements, components, groups, and/or steps, but do not exclude the presence of other unstated features, elements, components, groups, and/or steps. The foregoing also applies to words having similar meanings such as the terms, “including,” “having” and their derivatives. Any terms of degree such as “substantially,” “about” and “approximate” as used herein mean a reasonable amount of deviation of the modified term such that the end result is not significantly changed. When referring to a measurable value, such as an amount, a temporal duration, and the like, these terms are meant to encompass variations of at least ±20% or ±10%, more preferably ±5%, even more preferably ±1%, and still more preferably ±0.1% from the specified value, as such variations are appropriate and as would be understood by persons having ordinary skill in the art to which the invention pertains.

Throughout this disclosure, various aspects of the invention may be presented in a range format. It should be understood that the description in a range format is merely for convenience and brevity and should not be construed as an inflexible limitation on the scope of the invention. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 2.6, 3, 4, 5, 5.7, and 6. This applies regardless of the breadth of the range. As used herein, the terms “approximately” and “about” may refer to within +/−5% of.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In some implementations, a controller is part of a system, which may be part of the above-described examples. The controller, depending on the processing requirements and/or the type of system, may be programmed to control any of the processes disclosed herein.

Broadly speaking, the controller may be defined as electronics having various integrated circuits, logic, memory, and/or software that receive instructions, issue instructions, control operation, enable cleaning operations, enable endpoint measurements, and the like. The integrated circuits may include chips in the form of firmware that store program instructions, digital signal processors (DSPs), chips defined as application specific integrated circuits (ASICs), and/or one or more microprocessors, or microcontrollers that execute program instructions (e.g., software). Program instructions may be instructions communicated to the controller in the form of various individual settings (or program files), defining operational parameters for carrying out a particular process or method.

The controller, in some implementations, may be a part of or coupled to a computer that is integrated with the system, coupled to the system, otherwise networked to the system, or a combination thereof. For example, the controller may be in the “cloud” or all or a part of a host computer system. In some examples, a remote computer (e.g. a server) can communicate with a system over a network, which may include a local network or the Internet. The remote computer may include a user interface that enables entry or programming of parameters and/or settings, which are then communicated to the system from the remote computer. Thus as described above, the controller may be distributed, such as by comprising one or more discrete controllers that are networked together and working towards a common purpose, such as the processes and methods described herein. An example of a distributed controller for such purposes would be one or more integrated circuits in communication with one or more integrated circuits located remotely (such as at the platform level or as part of a remote computer) that combine to control a process or method.

What is claimed is:

1. A lock structure, comprising:
interior body having first and second openings;
a cable wire, wherein the interior body is configured to retain first and second ends of the cable wire when in a locked state;
an electrical sensing device disposed within the cable wire, the electrical sensing device including a first end and a second end; and
a signal sensing module electrically coupled to the electrical sensing device only at the first end of the electrical sensing device, wherein the signal sensing module is configured to (i) monitor, via the first end of the electrical sensing device, at least one of electrical and temperature characteristics of the electrical sensing device and (ii) selectively generate a notification indicating whether the cable wire is in a tampered-with state or untampered-with state based on the at least one of the electrical and temperature characteristics.

2. The lock structure of claim 1, wherein the electrical sensing device includes a flexible printed circuit coupled to the signal sensing module.

3. The lock structure of claim 2, wherein the flexible printed circuit is disposed between the cable wire and an outer layer enclosing the cable wire.

4. The lock structure of claim 1, wherein the electrical sensing device extends from the signal sensing module substantially along a length of the cable wire and terminates at a portion of the cable wire that is enclosed within the lock structure when in the locked state.

5. The lock structure of claim 1, wherein the electrical sensing device includes a sensing wire embedded within the cable wire.

6. The lock structure of claim 5, wherein the cable wire includes a plurality of wires and the sensing wire is embedded within the plurality of wires.

7. The lock structure of claim 6, wherein the sensing wire is enclosed within an insulation layer that electrically insulates the sensing wire from the plurality of wires.

8. The lock structure of claim 7, wherein the insulation layer extends from a first end of the sensing wire and terminates prior to a second end of the sensing wire within the cable wire such that the second end of the sensing wire is in electrical contact with the cable wire.

9. The lock structure of claim 8, wherein the insulation layer terminates at a portion of the cable wire that is enclosed within the lock structure when in the locked state.

10. The lock structure of claim 7, wherein the insulation layer is transparent.

11. The lock structure of claim 6, wherein the sensing wire has a substantially same diameter as individual wires of the plurality of wires.

12. The lock structure of claim 1, wherein the signal sensing module includes radio frequency identification (RFID) circuitry configured to generate and transmit the notification.

13. The lock structure of claim 1, wherein the signal sensing module includes Bluetooth circuitry configured to generate and transmit the notification.

14. The lock structure of claim 13, wherein the Bluetooth circuitry include Bluetooth low energy (BLE) circuitry.

15. A method of generating and providing an indication of whether a cable wire of a lock structure is in a tampered-with state or an untampered-with state, the method comprising:
electrically coupling a signal sensing module to only a first end of an electrical sensing device embedded within the cable wire; and
using one or more processing devices
monitoring, via the first end of the electrical sensing device, at least one of electrical and temperature characteristics of the electrical sensing device, and
selectively generating a notification indicating whether the cable wire is in the tampered-with state or the untampered-with state based on the at least one of the electrical and temperature characteristics.

16. The method claim 15, wherein the electrical sensing device includes a flexible printed circuit coupled to the signal sensing module.

17. The method of claim 15, wherein the electrical sensing device extends from the signal sensing module substantially along a length of the cable wire and terminates at a portion of the cable wire that is enclosed within the lock structure when the lock structure is in a locked state.

18. The method of claim 15, wherein the electrical sensing device includes a sensing wire embedded within the cable wire.

19. The method of claim 18, wherein at least one of:
The cable wire includes a plurality of wires and the sensing wire is embedded within the plurality of wires;
the sensing wire is enclosed within an insulation layer that electrically insulates the sensing wire from the plurality of wires;
the insulation layer extends from a first end of the sensing wire and terminates prior to a second end of the sensing wire within the cable wire such that the second end of the sensing wire is in electrical contact with the cable wire;
the insulation layer terminates at a portion of the cable wire that is enclosed within the lock structure when in the lock structure is in a locked state; and
the insulation layer is transparent.

20. The method of claim 15, wherein the signal sensing module includes at least one of (i) radio frequency identification (RFID) circuitry configured to generate and transmit the notification and (ii) Bluetooth circuitry configured to generate and transmit the notification.
